(19) United States
(12) Patent Application Publication
(10) Pub. No.: US 2008/0125055 A1
(43) Pub. Date: May 29, 2008

(54) Apparatus and method for controlling mobile communication terminal based on user's contact

(75) Inventors: Chi Ho Choi, Metropolitan City (KR); Young Choi, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/643,879

(22) Filed: Dec. 22, 2006

(30) Foreign Application Priority Data
Jul. 6, 2006 (KR) 2006-0063431

(51) Int. Cl. H04B 1/00

(52) U.S. Cl. 455/68

(57) ABSTRACT

An apparatus and method for controlling a mobile communication terminal based on contact that allows input of various user's contact information through a contact sensor are provided, which includes a contact sensor contact sensor that includes a plurality of contact switches arranged in a grid array and sensing the user's contact to produce contact signals. A contact information generator generates contact information using the contact signals. A controller determines whether the contact information is preset contact information, and executes a command that is set corresponding to the contact information if the contact information is preset contact information, or sets a command to be executed corresponding to the contact information if the contact information is not preset contact information. The grid arrangement of the contact switches allows input of contact information using various methods. Accordingly, a user can directly set or modify a method for inputting a command for controlling a function.

### CROSS-REFERENCE TO RELATED PATENT APPLICATION

This application claims the benefit under 35 U.S.C. § 119(a) of Korean Patent Application filed in the Korean Intellectual Property Office on Jul. 6, 2006 and assigned, Serial No. 2006-0063431, the entire disclosure of which is hereby incorporated by reference.

### BACKGROUND OF THE INVENTION

1. Field of the Invention

The present invention relates to a mobile communication terminal and a method for controlling the same. More particularly, the present invention relates to an apparatus and method for controlling functions of a mobile communication terminal based on user's contact.

2. Description of the Related Art

A mobile communication terminal was originally a digital device simply for delivering audio information. However, with the advancement in information and telecommunication technologies, the mobile communication terminal has recently evolved to incorporate diverse functions, such as delivering character information and video information, MP3 player functions, and games. The evolving has led to an advent of a mobile communication terminal having a wide variety of multimedia functions. As the number of functions of the mobile communication terminal increases, the need for a new user interface becomes more important.

In recent years, the use of contact switches that perform switching operations based on the body's contact has become widespread. A contact switch enabling switching only with the body's contact is easier to use than a mechanical switch using a keypad for input. In particular, navigation or scroll features can be implemented using a combination of contact switches. A contact sensor consists of multiple contact switches.

FIG. 1 is a plan view of an example of a contact sensor 110 in a conventional apparatus for controlling a mobile communication terminal based on user's contact. FIG. 2 is a plan view of another example of a contact sensor 210 in a conventional apparatus for controlling a mobile communication terminal based on user's contact. Referring to FIG. 1, the contact sensor 110 includes a plurality of contact switches 112 arranged in a linear array. Alternatively, referring to FIG. 2, the contact sensor 210 includes a plurality of contact switches 212 arranged in a circular array.

Thus, a user can control functions of the mobile communication terminal by touching the linear contact sensor 110 with their fingers and moving the fingers left or right on the linear contact sensor 110. Alternatively, the user can achieve the same purpose by touching the circular contact sensor 210 with their fingers and moving the fingers in a clockwise or counterclockwise direction around the circular contact sensor 210. That is, switching information pertaining to contact switches positioned at points contacted by their fingers is used as commands for controlling the functions of the mobile communication terminal.

However, the number of methods of inputting a command by contacting the contact sensor 110 or 120 is limited because the plurality of contact switches 112 or 212 in the contact sensor 110 or 210 is arranged in an array. That is, when the contact switches 112 are arranged in a linear pattern as illustrated in FIG. 1, the user can input a command through short touch, long touch, or scrolling left or right. When the contact switches 212 are arranged in a circular fashion as illustrated in FIG. 2, the user can input a command through short touch, long touch, or scrolling in a clockwise or counterclockwise direction.

Further, because methods for inputting a command through the contact sensor 110 or 210 are predetermined, the user cannot randomly set or modify a method for inputting a command. Thus, the conventional apparatus for controlling a mobile communication terminal based on user's contact has a drawback that the user cannot set a desired function or randomly modify the way a command is input.

Accordingly, there is a need for an improved apparatus and method for setting and modifying an input command for controlling a function of a mobile communication terminal.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and method for controlling a mobile communication terminal based on user's contact that allow input of user's contact information through a contact sensor including a plurality of contact switches arranged in a grid array.

Another aspect of exemplary embodiments of the present invention is to provide an apparatus and method for controlling a mobile communication terminal based on user's contact that allow a user to directly set or modify a method of inputting a command.

In order to achieve the above aspects, according to an exemplary embodiment of the present invention, there is provided an apparatus for controlling a mobile communication terminal based on user's contact, including a contact sensor, a contact information generator, a storage unit, and a controller. The contact sensor has a plurality of contact switches arranged in a grid array and sensing the user's contact to produce contact signals. The contact information generator generates contact information using the contact signals. The storage unit stores commands set corresponding to preset contact information and commands to be executed corresponding to contact information to be set. The controller determines whether the contact information is the preset contact information, extracts a command that is set corresponding to the contact information from the storage unit to execute the command if the contact information is the preset contact information, and sets a command to be executed corresponding to the contact information if the contact information is not the preset contact information.

In an exemplary implementation, the contact sensor further includes a plurality of light-emitting devices disposed in close proximity to the plurality of contact switches and indicating the user's contact to the contact switches.

In another exemplary implementation, the apparatus may further include a light-emitting device blinking unit for controlling the light-emitting devices to selectively blink based on the contact information.

In still another exemplary implementation, the contact switches may be arranged in a grid with n rows and m columns, where n and m are natural numbers greater than 1.

According to another exemplary embodiment of the present invention, there is provided a method for controlling a mobile communication terminal based on user's contact, in which the user's contact from a plurality of contact switches arranged in a grid array are sensed to generate contact information; whether the contact information is preset contact information is determined; if the contact information is preset contact information, a command that is set corresponding to the contact information is executed; and if the contact information is not preset contact information, a command to be executed corresponding to the contact information is set.

In an exemplary implementation, light-emitting devices disposed in close proximity to the plurality of contact switches are selectively blinked in order to indicate a contact to the contact switches to the user.

In another exemplary implementation, t the set command and the contact information are stored.

### BRIEF DESCRIPTION OF THE DRAWINGS

The above and other objects, features and advantages of the present invention will be more apparent from the following detailed description in conjunction with the accompanying drawings, in which:

FIG. 1 is a plan view of an example of a contact sensor in a conventional apparatus for controlling a mobile communication terminal based on user's contact;

FIG. 2 is a plan view of another example of a contact sensor in a conventional apparatus for controlling a mobile communication terminal based on user's contact;

FIG. 3 is a block diagram illustrating a configuration of an apparatus for controlling a terminal based on user's contact according to an exemplary embodiment of the present invention;

FIG. 4 is a plan view of a contact sensor of the apparatus of FIG. 3;

FIG. 5 is a diagram illustrating an example of information about the setting of commands corresponding to contact information, which is stored in a storage unit of the apparatus of FIG. 3;

FIG. 6 is a plan view of an exemplary implementation of a mobile communication terminal comprising the apparatus of FIG. 3; and

FIG. 7 is a flowchart illustrating a method for controlling a terminal based on user's contact according to an exemplary embodiment of the present invention.

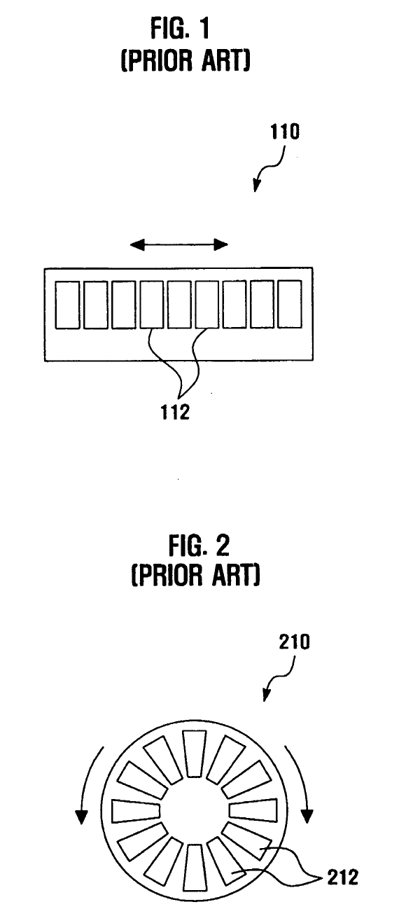

Throughout the drawings, the same drawing reference numerals will be understood to refer to the same elements, features and structures.

### DETAILED DESCRIPTION OF EXEMPLARY EMBODIMENTS

The matters defined in the description such as detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

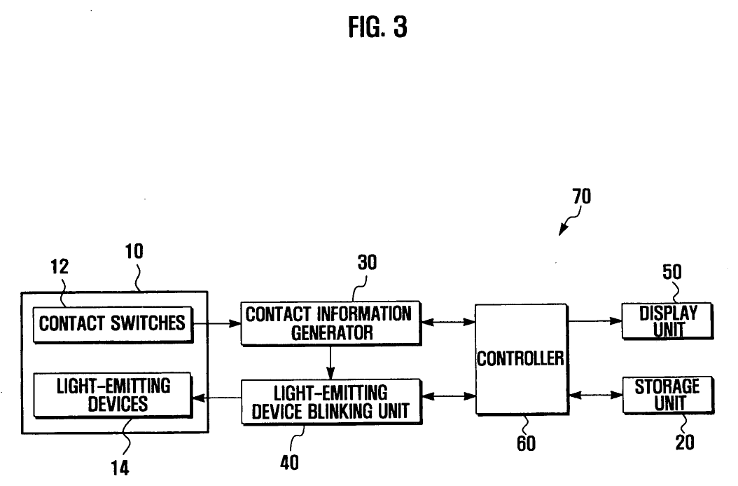

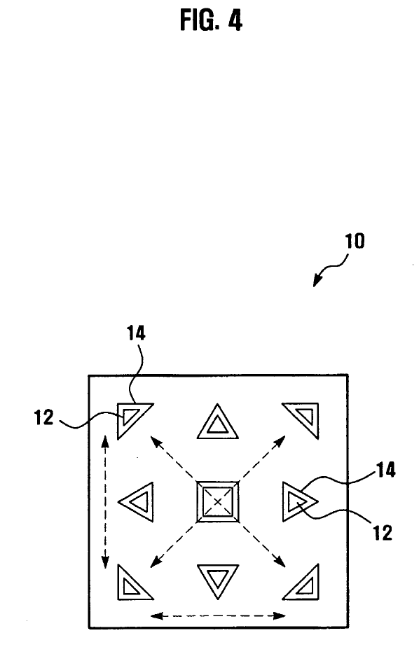

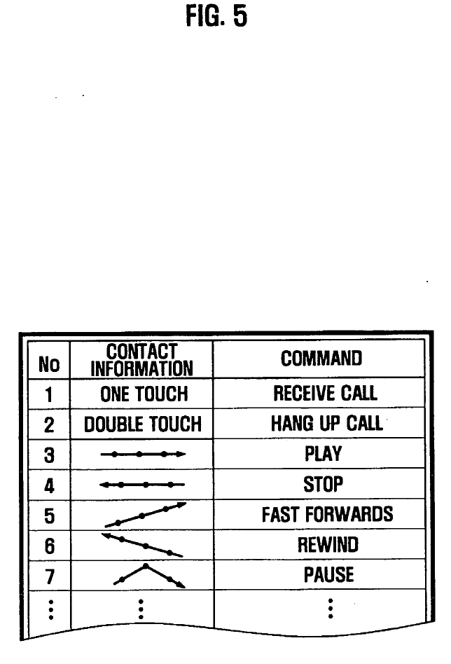

FIG. 3 is a block diagram illustrating a configuration of an apparatus 70 for controlling a mobile communication terminal based on user's contact according to an exemplary embodiment of the present invention. FIG. 4 is a plan view of a contact sensor 10 of the apparatus 70. FIG. 5 is a diagram illustrating an example of information about the setting of commands corresponding to contact information, which is stored in a storage unit 20 of the apparatus 70.

Referring to FIGS. 3-5, the apparatus 70 includes a contact sensor 10, a storage unit 20, a contact information generator 30, a light-emitting device blinking unit 40, a display unit 50 and a controller 60.

The contact sensor 10 includes a plurality of contact switches 12 that sense contact by a user to produce contact signals and a plurality of light-emitting devices 14 that are disposed in close proximity to the plurality of contact switches 12.

The contact switches 12 are arranged in a grid array, for example a matrix with n rows and m columns (where n and m are natural numbers greater than 1). This grid arrangement allows a user to input various contact information through the contact sensor 10. That is, the arrangement allows the user to input contact information by contacting the contact switches 12 in various ways, such as touch and scrolling left or right, in a diagonal direction, and in an inverted “V” pattern. In an exemplary implementation, the contact switches 12 are arranged in a 3×3 matrix form.

Each of the contact switches 12 includes an input element that senses contact by the user using heat, pressure, capacitance and resistance, and converts the sensed contact into a contact signal. The contact switch 12 may sense physical contact from a part of the user's body, or contact through a conductor or non-conductor other than the body. The contact switch 12 may also sense strength of contact.

The light-emitting devices 14 are disposed in close proximity to the plurality of contact switches 12 and emit light to indicate whether the user contacted the contact switch 12. In this case, the light-emitting devices 14 may be light-emitting diodes (LEDs). The light-emitting devices 14 emit various colors.

The light-emitting devices 14 may correspond one-to-one with the contact switches 12, or one contact switch 12 may correspond to n light-emitting devices 14, or n contact switches 12 may correspond to one light-emitting device 14. In this case, n is a natural number greater than 1. If the light-emitting devices 14 correspond one-to-one with the contact switches 12, one light-emitting device 14 blinks when there is a user's contact with the corresponding one of the contact switches 12. If one contact switch 12 corresponds to n light-emitting devices 14, two or more light-emitting devices 14 blink when there is a user's contact with the corresponding one of the contact switches 12. If n contact switches 12 correspond to one light-emitting device 14, one light-emitting device 14 blinks when there is a user's contact with two or more of the contact switches 12 corresponding to the one light-emitting device 14.

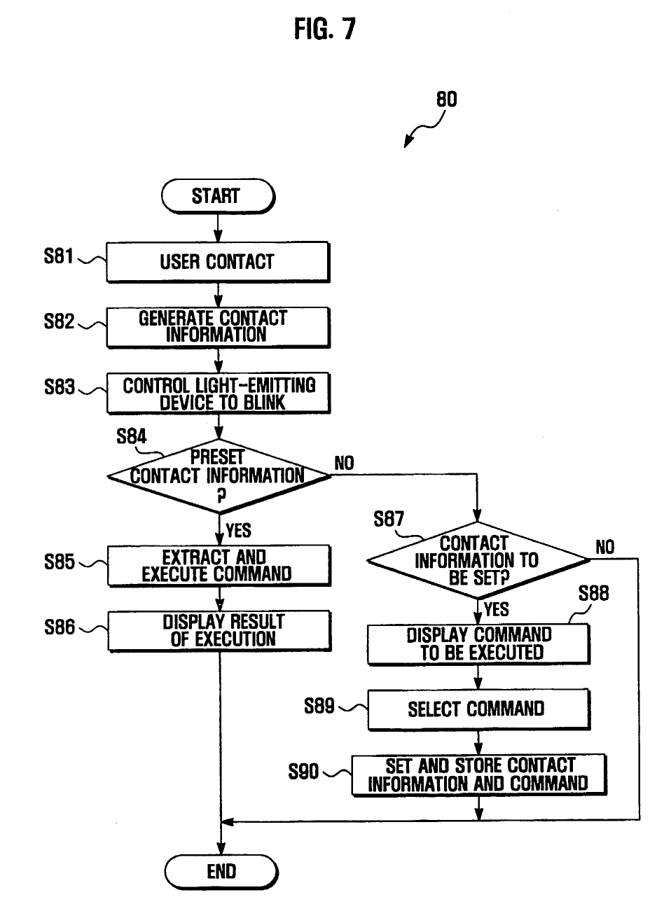

The storage unit 20 stores all programs that are required for performing a control function and other related functions of the apparatus 70 for controlling a mobile communication terminal. For example, the storage unit 20 stores information about the setting of commands corresponding to contact information (“command setting information”), as illustrated in FIG. 5. The command setting information consists of contact information and commands corresponding to contact information. The command setting information contains commands set corresponding to preset contact information and commands that will be executed corresponding to contact information to be set. Although default command setting information is provided at the time of manufacture of a mobile communication terminal, such information may be newly set or modified by a user, which will be described later with reference to FIG. 7.

The contact information is input by contacting the contact switches 12 in various ways, for example by touching, scrolling left or right, scrolling in a diagonal direction, and scrolling in an inverted “V” pattern on the contact switches 12. Referring to FIG. 5, first and second contact information (Nos. 1 and 2) means a touch and a double touch respectively. Third and fourth contact information (Nos. 3 and 4) indicates scrolling right and left respectively. Fifth and sixth contact information (Nos. 5 and 6) indicate diagonal scrolling from bottom-left to top-right and from bottom-right to top-left respectively. Seventh contact information (No. 7) indicates scrolling in an inverted “V” pattern consisting of scrolling from bottom-left through top-center to bottom-right.

The contact information generator 30 uses a contact signal output from the contact sensor 10 to generate contact information. That is, the contact information generator 30 generates contact information using a sequence of signals produced when the user intermittently or sequentially contacts the contact switches 12.

The light-emitting device blinking unit 40 causes the light-emitting devices to selectively blink based on the contact information. The light-emitting device blinking unit 40 receives the contact information from the contact information generator 30 and controls the light-emitting device 14 that is positioned in close proximity to the contact switch 12 contacted by the user to blink, thus indicating the user's contact with the contact switch 12.

The display unit 50 displays menus for various functions performed by the apparatus 70 as well as services being provided according to commands stored in the storage unit 20. In particular, the display unit 50 displays images or video related to a result of execution according to the contact information and to setting the contact information. A liquid crystal display (LCD) can be commonly used as the display unit 50.

The controller 60 controls the operation of each component of the apparatus 70 based on the contact information and controls the display unit 50 to display the result of control. For example, the controller 60 determines whether the contact information is preset contact information. If the contact information is preset contact information, the controller 60 extracts a command corresponding to the contact information from the storage unit 20 and executes the command. If the contact information is not preset contact information, the controller 60 sets a command that will be executed corresponding to contact information input according to user selection information.

The contact sensor 10, the contact information generator 30, and the light-emitting device blinking unit 40 can be constructed as a single module. This construction can reduce the length of interconnections among the contact sensor 10, the contact information generator 30, and the light-emitting device blinking unit 40, thus increasing integration density of the mobile communication terminal while preventing electrical failures such as wire breakage and electrical leakage.

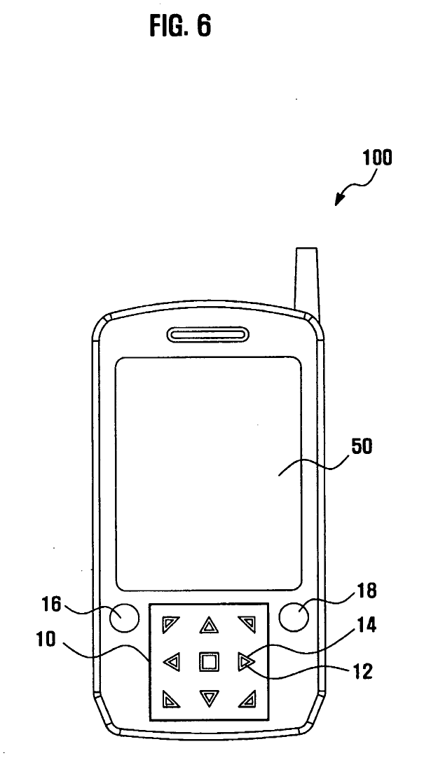

An apparatus for controlling a terminal based on user's contact according to an exemplary embodiment of the present invention can be applied to a mobile communication terminal 100 as shown in, for example, FIG. 6. FIG. 6 is a plan view of the mobile communication terminal 100 comprising the apparatus 70 of FIG. 3. Referring to FIG. 6, the contact sensor 10 is disposed below the display unit 50. A confirm key 16 and a cancel key 18 are positioned at the top of the right and left side respectively of the contact sensor 10. Although not shown, a contact information generator, a storage unit, a light-emitting device blinking unit and a controller may be disposed in the mobile communication terminal 100.

Thus, when a user moves their fingers to contact the contact sensor 10, the contact information generator and the controller operate to control the mobile communication terminal 100. For example, if the user touches the contact sensor 10 once, the mobile communication terminal 100 performs a call-receiving function. If the user double-touches the contact sensor 10, the terminal performs a hanging-up function. When the user scrolls the contact sensor in a linear or diagonal direction, the terminal performs an MP3 play function. At the same time, the light-emitting device blinking unit controls the light-emitting devices 14 to blink, thus visually informing the user of movement of their fingers as the user contacts the contact switches 12. For example, the light-emitting device blinking unit may control the light-emitting device 14 near the contact switch 12 being contacted by the user to blink while controlling the remaining light-emitting devices 14 to turn off or emit low intensity light.

FIG. 7 is a flowchart illustrating a method 80 for controlling a mobile communication terminal based on user's contact according to an exemplary embodiment of the present invention. The method 80 is performed using the apparatus 70 of FIG. 3. The steps of the method 80 are described in more detail with reference to FIGS. 3-7.

The method 80 begins when a user makes a contact with the contact sensor 10 (S81). The contact switches 12 of the contact sensor 10 sense the user's contact to generate contact signals. In this case, because the contact switches 12 are arranged in a grid array, the user can input contact information by contacting the contact switches 12 using various methods.

The contact information generator 30 generates contact information using the contact signals output from the contact sensor 10 (S82). That is, the contact information generator 30 generates contact information using a sequence of signals produced when the user intermittently or sequentially contacts the contact switches 12.

The light-emitting device blinking unit 40 then controls the light-emitting devices 14 to selectively blink based on the contact information (S83). For example, in order to indicate the contact switch 12 with which a user makes a contact, the light-emitting device blinking unit 40 may control the light-emitting device 14 near the contact switch 12 being contacted by the user to blink while controlling the remaining light-emitting devices 14 to turn off or emit low intensity light.

Next, the controller 60 determines whether the input contact information is preset contact information (S84). That is, by comparing the input contact information with the preset contact information stored in the storage unit 20, the controller 60 determines whether the input contact information is contained in the preset contact information.

If the input contact information is preset contact information in step S84, the controller 60 extracts a command corresponding to the contact information from the storage unit 20 and executes the command (S85). The controller 60 then controls the display unit 50 to display the result of execution as images or video (S86).

If the input contact information is not preset contact information in step S84, the controller 60 determines whether to set the input contact information (S87). In this case, the controller 60 controls the display unit 50 to display a window requesting whether to set the input contact information. The user selects the confirm key 16 or cancel key 18 to determine whether to set the input contact information. Alternatively, the user may program the controller 60 to determine whether to set the input contact information through the contact sensor 10. For example, when the window is displayed on the display unit 50, a touch or double touch on the contact sensor 10 may be used instead of input of the confirm or cancel key.

If the user selects the confirm key 16, the controller 60 sets a command to be executed corresponding to contact information input according to user selection information. That is, the controller 60 controls the display unit 50 to display commands to be executed corresponding to the input contact information (S88). By selecting the displayed command confirmed through the confirm key 16, the controller 60 sets the command to be executed according to the input contact information (S89). The controller 60 then controls the storage unit 20 to store the input contact information and the command to be executed according to the input contact information (S90).

If the user selects the cancel key 18 in step S87, the controller 60 determines the contact information as incorrectly input contact information and terminates execution of a function corresponding to the incorrectly input contact information.

In this case, the contact information input by the user may be information for modifying the preset contact information or for setting a new contact information corresponding to a command for execution.

As described above, an apparatus and method for controlling a mobile communication terminal based on user's contact according to the exemplary embodiments of the present invention allow input of contact information using various methods. The exemplary embodiments of the present invention also enable a user to directly set or modify a method for inputting a command for controlling a function. That is, the user can set a command to be executed corresponding to contact information being input through a contact sensor, thus allowing the creation of a unique user interface of the mobile communication terminal.

While the present invention has been particularly shown and described with reference to certain exemplary embodiments thereof, it will be understood that various changes in form and details may be made therein without departing from the spirit and scope of the present invention as defined by the appended claims.

What is claimed is:

1. An apparatus for controlling a mobile communication terminal, the apparatus comprising:
a contact sensor comprising a plurality of contact switches arranged in a grid array and sensing a contact to produce contact signals;
a contact information generator for generating contact information using the contact signals;
a storage unit for storing at least one command set corresponding to preset contact information and at least one command to be executed corresponding to contact information to be set; and
a controller for determining whether the contact information is the preset contact information, extracting a command set corresponding to the contact information from the storage unit to execute the command if the contact information is the preset contact information, and setting a command to be executed corresponding to the contact information if the contact information is not the preset contact information.

2. The apparatus of claim 1, wherein the contact sensor further comprises a plurality of light-emitting devices indicating the contact to the contact switches.

3. The apparatus of claim 2, further comprising a light-emitting device blinking unit controlling the light-emitting devices to selectively blink based on the contact information.

4. The apparatus of claim 1, wherein the contact switches comprise contact switches arranged in a grid with n rows and m columns, where n and m are positive integers greater than 1.

5. A method for controlling a mobile communication terminal, the method comprising:
sensing a contact from at least one of a plurality of contact switches arranged in a grid array to generate contact information;
determining whether the contact information comprises preset contact information;
if the contact information comprises preset contact information, executing a command set corresponding to the contact information; and
if the contact information does not comprise preset contact information, setting a command to be executed corresponding to the contact information.

6. The method of claim 5, further comprising selectively blinking light-emitting devices to indicate a contact to the contact switches.

7. The method of claim 6, wherein the contact switches are arranged in a grid with n rows and m columns, where n and m are positive integers greater than 1.

8. The method of claim 5, further comprising storing at least one of the set command and the contact information.

9. The apparatus of claim 2, wherein the plurality of light-emitting devices is disposed in close proximity to the plurality of contact switches.

10. The apparatus of claim 1, further comprising a display unit for displaying at least one of images and video related to at least one of an execution result according to the contact information and setting of the contact information.

11. The method of claim 6, wherein the selectively blinking light-emitting devices are disposed in close proximity to the plurality of contact switches.

12. The method of claim 1, further comprising displaying at least one of images and video related to at least one of an execution result according to the contact information and setting of the contact information.

13. A method for controlling a mobile communication terminal, the method comprising:
sensing contact from at least one of a plurality of contact switches arranged in a grid array to generate contact information;
generating contact information using the contact signals; and
storing commands set corresponding to preset contact information and commands executed corresponding to contact information set.

14. The method of claim 13, further comprising:
determining whether the contact information comprises preset contact information;
if the contact information comprises preset contact information, executing a command set corresponding to the contact information; and
if the contact information does not comprise preset contact information, setting a command to be executed corresponding to the contact information.

15. The method of claim 13, further comprising selectively blinking light-emitting devices to indicate a contact to the contact switches.

16. The method of claim 15, wherein the contact switches are arranged in a grid with n rows and m columns, where n and m are positive integers greater than 1.

17. The method of claim 13, further comprising displaying at least one of images and video related to at least one of an execution result according to the contact information and setting of the contact information.

18. The method of claim 15, wherein the selectively blinking light-emitting devices are disposed in close proximity to the plurality of contact switches
